(19) United States
(12) Patent Application Publication
(10) Pub. No.: US 2007/0205240 A1
(43) Pub. Date: Sep. 6, 2007

(54) Vehicle top carriers

(76) Inventors: Jeff Castro, Portland, OR (US); Jason Carothers, Portland, OR (US); Steve Rodden, Sherwood, OR (US); Andrew Austin, Sherwood, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/585,670

(22) Filed: Oct. 23, 2006

Related U.S. Application Data
(60) Provisional application No. 60/729,503, filed on Oct. 21, 2005.

(51) Int. Cl. B60R 9/048; B60R 9/055

(52) U.S. Cl. 224/328; 224/324

(57) ABSTRACT

Improvements for a carrier configured to be mounted on a roof of a vehicle, including a removable floor cover configured to provide a protective layer on the floor of the carrier and/or to dampen sound produced within the carrier. In some embodiments, the cover may include floor conforming structures such as ribs or apertures, to conform the cover to the floor of the carrier and/or to accommodate mounting structures attached to or integral with the floor of the carrier.

### CROSS REFERENCE TO RELATED APPLICATIONS

This application is based upon and claims priority under 35 U.S.C. § 119 from U.S. Provisional Patent Application Ser. No. 60/729,503 filed Oct. 21, 2005, which is incorporated herein by reference in its entirety for all purposes.

This application also incorporates by reference in their entirety for all purposes the following U.S. Pat. No. 6,905,053 issued Jun. 14, 2005; and U.S. Pat. No. 6,918,521 issued Jul. 19, 2005. This application also incorporates by reference in their entirety for all purposes the following U.S. patent application Ser. No. 10/767,398 filed Jan. 28, 2004; and U.S. Ser. No. 11/152,674, filed Jun. 13, 2005.

### FIELD OF THE INVENTION

The invention relates to assemblies for carrying cargo items on a vehicle. In particular, the invention provides improvements for cargo boxes or cargo trunks, collectively termed vehicle top carriers, designed for mounting on the roof of a vehicle and transporting sporting goods or other cargo.

### BACKGROUND

Vehicle top carriers, such as cargo boxes or cargo trunks, have become quite popular in recent years. Enclosed carriers may be preferable over conventional open racks for a variety of reasons. For example, enclosed carriers protect cargo items from the elements such as wind, rain, and snow. Additionally, enclosed carriers may be more secure from theft or vandalism. Yet another advantage is that enclosed carriers may allow items to be fixed to the carrier in a simpler, less elaborate manner than exposed cargo roof racks, since security and stability for items within the carrier is provided partially by the carrier itself.

Some vehicle top carriers, however, have problems associated with the use of the carrier on a vehicle, storage of cargo items within the carrier, and/or storage of the empty carrier when removed from the vehicle. One example of such a problem is a possible increase in drag and noise when the vehicle to which the carrier is mounted is moving, due to air traveling between the underside of the carrier and the top of the vehicle. Another example is that some vehicle top carriers may require a significant and inconvenient amount of room or shelf space to store when not mounted to a vehicle. Yet another example is that some vehicle top carriers have interior floors that are easily scuffed and/or damaged by equipment or other cargo items placed in those carriers, and which fail to dampen sounds produced within the carrier. Still another example is that some vehicle top carriers are not equipped with structures capable of securely retaining cargo items, to prevent those items from being damaged and/or from creating noise when the vehicle is moving.

In addition to the problems noted above, some vehicle top carriers may not include any means for illuminating the interior of the carrier, which makes it difficult to install or remove cargo items from the carrier, particularly in the dark. Some vehicle top carriers also may require height-augmenting devices, such as ladders, which may make it tedious to load, secure, and/or remove the contents of the carrier. Additionally, some vehicle top carriers may require users to climb on the vehicle to view the contents. Those carriers do not allow users to view the contents of the carrier from the ground. In light of these problems, a need exists for improved carriers that are more convenient to use and/or to store when not in use, that better protects cargo within the carrier and better dampens sound produced from with the carrier, and that retains cargo items in a more secure and convenient manner.

### BRIEF DESCRIPTION OF THE DRAWINGS

FIG. 1 is a side elevational view of a vehicle top carrier mounted on a vehicle and including a drag-resistant structure.

FIG. 2 shows an isometric view and a side elevational view of the vehicle top carrier of FIG. 1, equipped with a storage structure.

FIG. 3 shows an isometric view and a side elevational view of the vehicle top carrier of FIG. 1, equipped with an alternative embodiment of a storage structure.

FIG. 4 is an isometric view of the vehicle top carrier of FIG. 1, shown equipped with a floor cover.

FIG. 5 is a sectional view of a floor cover suitable for use in a vehicle top carrier.

FIG. 6 is a sectional view of an alternative embodiment of a floor cover suitable for use in a vehicle top carrier.

FIG. 7 is an isometric view of the vehicle top carrier of FIG. 1, shown equipped with a content retention structure holding cargo in place within the carrier

FIG. 8 is a partial sectional view showing an internal rail attached to the floor of a vehicle top carrier, and an internal tower attached to the internal rail.

FIG. 9 is an isometric view of the vehicle top carrier of FIG. 1, shown equipped with rack components for retaining cargo within the carrier.

FIG. 10 is an end elevational view of one of the rack components of FIG. 9, showing in further detail the attachment of the rack component to the internal towers of the carrier.

FIG. 11 is an end elevational view of an alternative embodiment of a rack component, showing how the component may be rotatably attached to the internal towers of the carrier.

FIG. 12 is an end elevational view of the vehicle top carrier of FIG. 1, shown equipped with an illumination device.

FIG. 13 is a partially exploded isometric view of the illumination device of FIG. 12, showing details of the construction and mounting of the device.

FIG. 14 is an end elevational view of the vehicle top carrier of FIG. 1 mounted to a vehicle and equipped with a viewing structure, illustrating how the viewing structure may assist a user in seeing the internal contents of the carrier.

### DETAILED DESCRIPTION

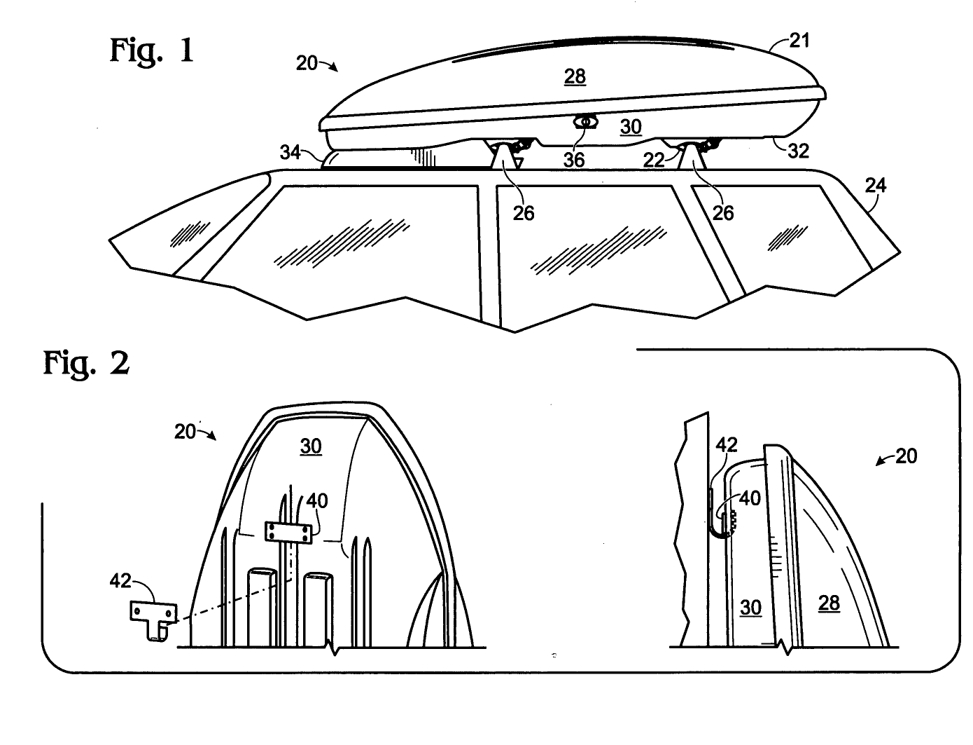

FIG. 1 shows a side elevational view of a vehicle top carrier 20 mounted on crossbars 22 of a roof rack of a vehicle 24. The long axis of vehicle top carrier 20 is perpendicular to crossbars 22, and crossbars 22 typically are attached to tower portions 26 of the vehicle roof rack. Vehicle top carrier 20 includes a box 21 having a top 28 rotatably connected to a bottom 30, which has a floor 32. Clamps (not shown) secure carrier 20 to crossbars 22. One or more drag-reducing structures, such as a fairing 34, is provided to reduce air resistance and/or noise due to air rushing between floor 32 and the top of the vehicle when the vehicle is in motion. Although fairing 34 is depicted in FIG. 1 to have a unitary structure, in general a fairing or other drag-reducing structure may include two or more components. A latch 36 keeps vehicle top carrier 20 closed, and may be operated to allow opening when desired. Latch 36 may be provided with a key, combination operated, and/or any suitable lock mechanism.

More generally, a drag-reducing structure may include not only a fairing, but any suitable structure or combination of structures configured to reduce drag and/or noise from the airflow over or under vehicle top carrier 20 when the vehicle is moving, including both air traveling over the top and around the sides of the carrier, and air traveling between the bottom of the carrier and the roof of the vehicle. For example, the drag-reducing structure may include at least one air dam or fairing configured to be mounted to the vehicle top carrier and/or to the crossbars of the vehicle roof rack. The drag-reducing structure may reduce drag and/or noise by eliminating, restricting, and/or deflecting the flow of air around the carrier, particularly between the carrier and the roof of the vehicle.

The drag-reducing structure(s) may be made of any suitable material configured to eliminate, restrict, and/or deflect airflow around the carrier or between the carrier and the vehicle. For example, semi-rigid materials, cloth, hard plastic, soft foam materials, and/or any other suitable material may be used. Additionally, the drag-reducing structure may be mounted on the carrier and/or crossbar via any suitable methods, such as with one or more clamps, snaps, screws, bolts, adhesives, etc. Attachment mechanisms may in some cases include clamps specifically configured to conveniently attach to common sizes and shapes of roof rack crossbars, or to common vehicle top carriers.

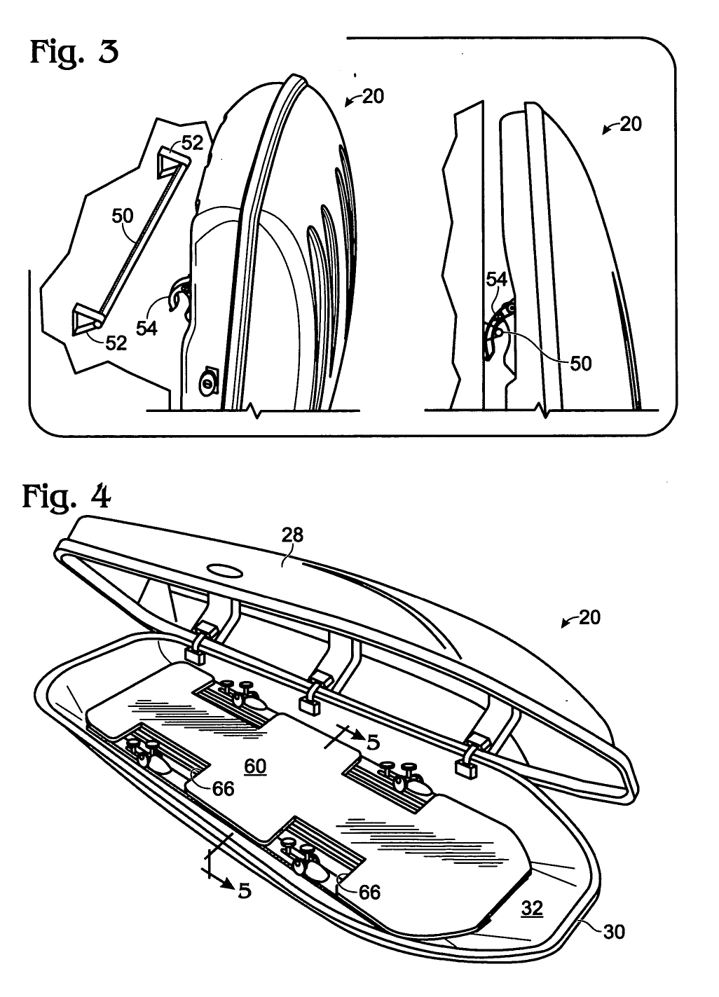

FIG. 2 shows vehicle top carrier 20 equipped with a storage structure, which may be any suitable structure configured to allow the vehicle top carrier to be supported (such as mounted and/or hung) vertically or horizontally on a wall, so as to minimize the space required for storage of the carrier. For example, in FIG. 2, the storage structure includes a plate 40 attached to the exterior of bottom 30 of the carrier, configured to hang on a complementary hook 42 that may be attached to any convenient location on a wall or ceiling (see FIG. 3). As depicted in FIG. 2, the plate may be attached to the carrier with screws or other fixation hardware, or it may be formed as an integral portion of the bottom of the carrier. More generally, a storage structure of the type shown in FIG. 2 may include two or more complementary pairs of hooks and plates, which may increase the stability of the carrier when stored using the storage structure.

Although in FIG. 2, plate 40 is shown located on the bottom of the vehicle top carrier, the plate also may be disposed in or attached to any other suitable portion of the carrier, such as top 28. Additionally, although the embodiment of FIG. 2 depicts a plate attached to the carrier and a hook configured for attachment to a wall or ceiling, equivalently, a hook may be attached to the carrier and a plate configured for attachment to a wall or ceiling. The hook and/or plate of the storage structure may be configured to be retracted into the bottom of the vehicle top carrier when the hook is not being used, such as when the carrier is mounted on the vehicle.

Furthermore, a storage structure may include not only plates and hooks, but any suitable structure configured to allow the carrier to be supported vertically or horizontally on a wall, ceiling, or other suitable location. Other examples of storage structures include a loop of cable or rope, a flip out metal or plastic loop, etc. One such specific alternative embodiment is shown in FIG. 3, which depicts a bar 50 mounted to two support brackets 52. Brackets 52 generally are configured for mounting to a vertical wall, but in some cases it may be more convenient to mount the brackets to a ceiling or other surface. Carrier 20 is equipped with a pair of clamps 54 (only one is visible in FIG. 3), which are configured to grip crossbars 22 of the vehicle roof rack, but which also may be used to grip or otherwise engage with bar 50, thus providing a stable storage mechanism for the carrier.

FIG. 4 shows vehicle top carrier 20 equipped with a floor cover 60. Floor cover 60 may include any suitable structure configured to create a protective layer on floor 32, to help prevent cargo items that are stored in the carrier from being scuffed and/or damaged by, for example, hard plastic and sheet metal surfaces or edges on the bottom of the carrier. A floor cover also may help to dampen any noise produced in the interior of the carrier, such as noise created by movement of the contents of the carrier. For example, the floor cover may include a floor pad made of suitable protective or sound-dampening material(s), such as foam, soft rubber, carpet-like material (e.g., woven cloth with a nap), and/or rubberized paint (such as an undercoating paint). This may both shield or separate the cargo items from hard plastic and/or sheet metal surfaces and edges on the bottom of the carrier, and also dampen vibrations and other noises.

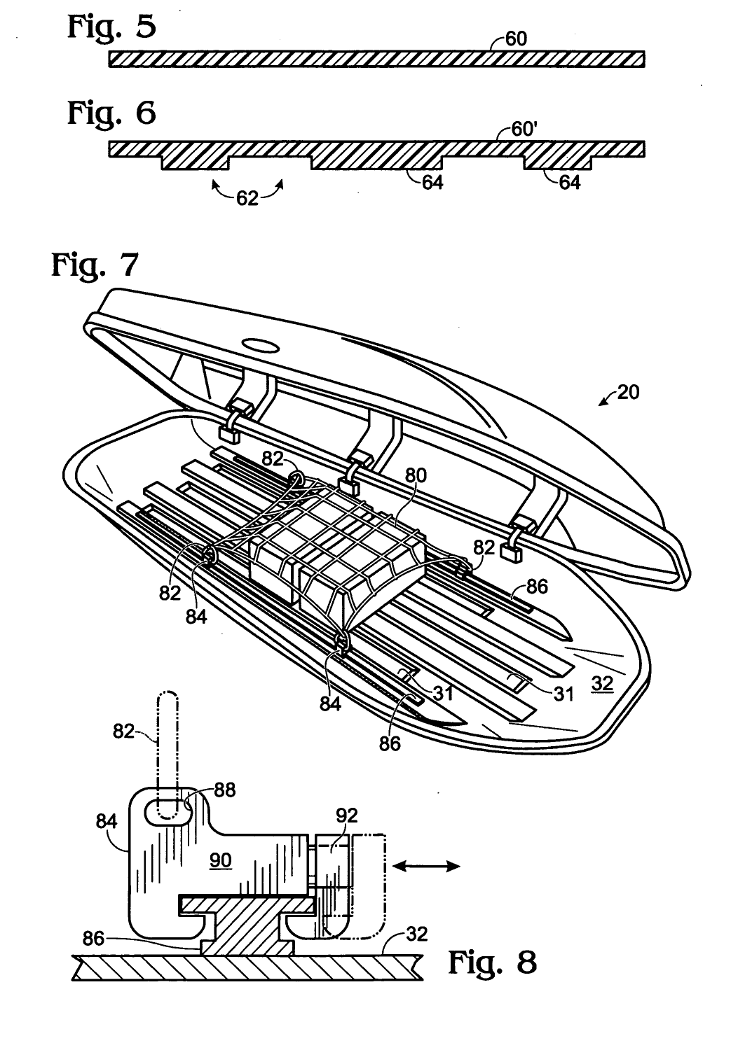

FIGS. 5 and 6 depict two possible configurations for the bottom of a floor cover such as cover 60. As depicted in FIG. 5, floor cover 60 simply may be flat on both sides. This may be particularly appropriate if the floor cover is constructed from a semi-rigid material that provides a substantially flat surface for cargo, regardless of the exact topology of the underlying floor of the carrier. On the other hand, as depicted in FIG. 6, an alternative floor cover 60′ may include one or more floor-conforming structures 62 configured to conform to floor 32 of the carrier. If, as is common, the carrier floor is not perfectly flat, this may help to secure the floor cover to the floor, and/or to maintain an at least substantially flat surface upon which cargo may rest.

For example, floor conforming structures 62 may include one or more ribs 64 or other suitable structures configured to be at least partially received in one or more recesses 31 of the floor of the carrier (see FIG. 7). In some embodiments, the floor cover also may include one or more apertures 66 configured to accommodate mounting structures on or attached to the floor of the carrier (see FIG. 4). These structures may include, for example, internal rails and/or towers of the type described in more detail below with reference to FIGS. 7-11. More specifically, the floor cover may include two or four apertures configured to accommodate two or four internal towers, and sized to allow adjustment of the towers through a series of longitudinal positions within the carrier. This may allow mounting of various internal rack components within the box while still accommodating the floor cover. Although floor conforming structures 62 are shown to include ribs and/or apertures, the floor conforming structures may include any suitable structure configured to conform to the floor of the carrier to provide a substantially flat surface within the box, to accommodate rails, towers, or other hardware within the box, and/or to assist in securing the floor pad to the floor of the carrier. Alternate floor conforming structures may, for example, include discrete protrusions, slots, notches, grooves, cutouts, or the like.

In some embodiments, the floor cover also may include a fluid containing structure (not shown), configured to contain liquids and/or dirt to simplify cleaning of the floor cover. For example, the floor cover may include a tray formed by an edge lip around the floor cover, such as around the perimeter portion of the cover. In addition to a perimeter lip, a fluid containing structure may include any other suitable structure configured to contain liquids and/or dirt so as to simplify cleaning of the floor cover.

FIG. 7 shows another example of vehicle top carrier 20, equipped with a content retention structure in the form of a cargo net 80 attached to the interior of the carrier. The cargo net is shown attached to the carrier by four carabiners 82 that are clipped to internal towers 84, which in turn are attached to internal rails 86 of the carrier. The structure of towers 84 and rails 86 will be described below in more detail. While FIG. 7 depicts a cargo net, in general a content retention structure includes any suitable structure configured to retain and/or secure cargo items packed in the carrier, so as to prevent smaller and loose items packed in the carrier from making noise and getting damaged due to vibration and/or shifting resulting from vehicle motions. For example, individual bungee cords and/or load straps with ratchet pawls may alternatively, or additionally, be used as content retention structures.

Cargo net 80 may be constructed from any suitable material, such as elastic and/or woven material. For example, the cargo net may be cut from non-elastic cloth with bungee tails configured to exert pressure on the cargo. Additionally, although the cargo net is depicted in FIG. 7 as being attached to internal towers 84, in general the cargo net may be attached to the carrier via any suitable attachment structures on the floor of the carrier, such as eye bolts or other hardware attached to the carrier, or integrated attachment structures, such as apertures or hooks incorporated into the carrier during its manufacture. The capacity of the cargo net may be adjusted based on which portions of the net are attached to the attachment structures. For example, small loads may be secured by attaching one or more inner portions of the net to the attachment structures, while large loads may be secured by attaching one or more outer or perimeter portions of the net to the attachment structures. Alternatively, or additionally, more than one net may be used for large loads.

FIG. 8 shows additional details of an internal tower 84 and an internal rail 86 attached to floor 32 of carrier 20. As shown, each tower 84 may include an aperture 88 through which various items may be attached. For example, as described previously and as indicated by dashed lines in FIG. 8, carabiners 82 may be attached through apertures 88 to secure a cargo net. Attachment of other items such as internal racks will be described below. Towers 84 generally include two integrated portions 90 and 92 having an adjustable separation, so that towers 84 are configured to selectively compress and securely grip rails 86. The two portions of each tower are shaped to conform to the shape of rails 86, which may as depicted have an approximate I-beam shape, and to slide along the rails for convenient longitudinal adjustment within the carrier.

Upon being located at a desired place along one of the rails, an internal tower 84 may be secured in place by reducing the separation between tower portions 90 and 92. As indicated by the double arrow in FIG. 8, the separation of portions 90 and 92 is adjustable. The adjustment mechanism (not shown) may include, for example, an internal spring that exerts tension between the two portions of the tower, or an adjustment screw or the like that may be used to draw the portions together, among others. Rails 86 may be secured to floor 32 of the carrier by any suitable hardware such as screws or bolts, the rails may be affixed to the carrier with an adhesive, or they may be formed integrally with the floor of the carrier. As depicted in FIG. 7, the internal rails may extend along a significant portion of the length of carrier 20, or in other embodiments, the rails may extend along a smaller fraction of the length of the carrier, or they may be segmented into discrete sections that are conveniently placed along the floor of the carrier.

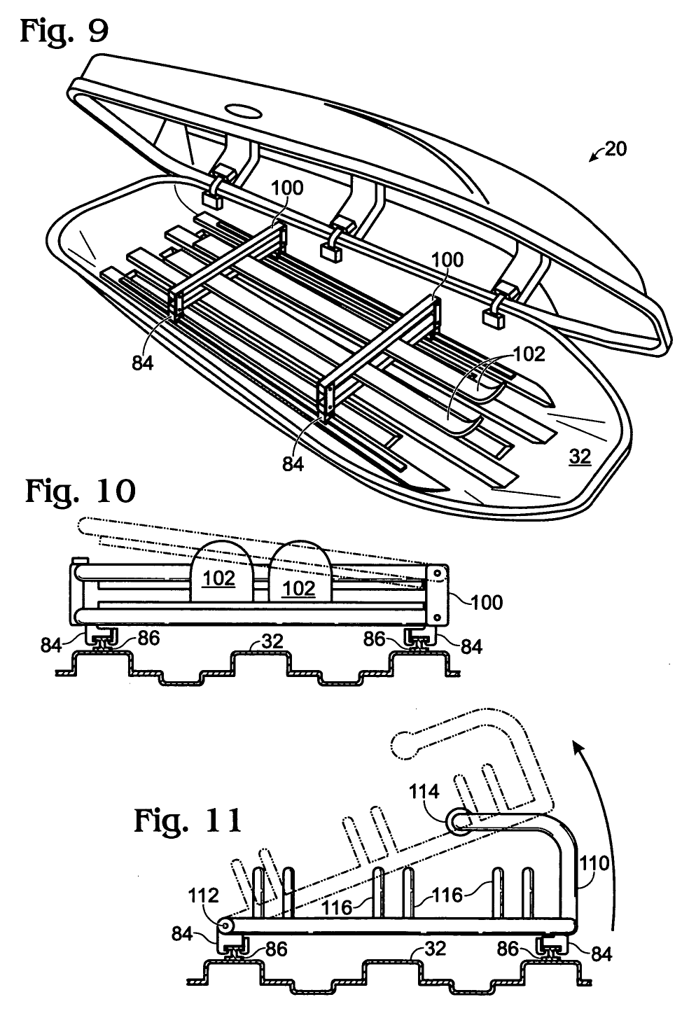

In addition to the cargo net depicted in FIG. 7, other components may be attached to towers 84 within carrier 20. For example, FIGS. 9-10 depict two rack components 100 attached to the towers. As shown in FIG. 9, the rack components may be disposed substantially across the width of the carrier or, in alternative embodiments, the rack components may extend only partially across the carrier. Rack components 100 are shown as ski rack components and are depicted holding two skis 102, but in general, various types of rack components may be attached to towers 84 and used to support or secure a variety of sporting gear or other cargo.

FIG. 10 is an end elevational view, showing a closer depiction of one of rack components 100 attached to a pair of towers 84. Each component 100 may, for example, include an attachment mechanism such as one or a pair of protruding pegs or other members (not shown), configured to fit into apertures 88 of the towers (see FIG. 8). The attachment mechanism of components 100 may hold the component securely in place by frictional engagement of the attachment members with apertures 88 or, in some embodiments, the attachment members may be threaded and used in conjunction with hardware such as a complementary threaded nut such as a butterfly nut that is screwed onto the member after it has passed through the aperture. In general, any attachment mechanism that securely engages each component 100 with one or more towers 84 may be suitable for use within the carrier. As FIG. 10 further depicts (in dashed lines), components 100 may be rotatable at one or both sides, to allow more convenient access to the skis or other cargo stored upon the rack component.

FIG. 11 is another end elevational view, showing an alternative rack component 110 attached to towers 84. Component 110 is shown attached to the left-hand tower of FIG. 11 via a rotatable attachment mechanism such as a detachable hinge 112. Component 110 may be releasably attached to the right-hand tower or, as depicted in FIG. 11, it may simply be configured to rest upon the right-hand tower so that it can be rotated upward using handle 114, without releasing it from either of the towers. This may allow more convenient access to any gear or cargo disposed within the rack component, by allowing a user to rotate the rack component toward an open side of the carrier when loading or unloading gear. As in the case of the ski rack components of FIGS. 9-10, two of components 110 may be used within carrier 20, spaced apart along the length of the carrier and extending partially or substantially across the carrier's width. In FIG. 11, component 110 is configured to support skis or snowboards between pairs of support members 116, but in general any rack component may be configured to be rotatably attached to towers 84 in the same manner.

Alternative rack components, also known as load structures, may include any suitable structure configured to secure various equipment and/or other contents together and/or to the carrier. Equipment to be secured may include sporting equipment, such as skis, poles, paddles, fishing gear, etc., or it may include more general forms of cargo. Additionally, the load structures may include any suitable structure configured to function as a loading aid when not in the carrier. For example, the load structures may include one or more equipment loading racks. The equipment loading racks may include equipment fasteners for attaching equipment to the loading rack, carrier fasteners for attaching the loading rack to the carrier, and/or handles for convenient manipulation of the loading rack.

The equipment fasteners may include any suitable structure configured to secure one or more pieces of equipment and/or other contents together and/or to the equipment loading rack. For example, equipment fasteners may include one or more straps, clamps, bolts, cords, grips, etc. The equipment fasteners may be configured to allow individual items to be accessed and/or removed while the equipment loading rack is still secured to the carrier.

The carrier fasteners may include any suitable structure configured to secure the equipment loading rack to the inner compartment of the carrier. For example, carrier fasteners may include one or more straps, clamps, bolts, cords, grips, etc, configured to attach to one or more receiving portions of the carrier such as the internal towers or rails described previously. The handles of the loading rack may include any suitable structure configured to allow a user to remove, install, or otherwise manipulate the equipment loading rack in the inner compartment of the carrier. Additionally, the handles may include any suitable structure configured to allow a user to carry the equipment loading rack when the loading rack is removed from the carrier, possibly with the equipment and/or contents still secured to the rack. For example, handle 114 of rack component 110 depicted in FIG. 11 may be used to carry component 110 when it is removed from the carrier.

Equipment loading racks according to the present disclosure may be used to secure skis, paddles, fishing rods, or any other suitable equipment or other contents (or any combination thereof). Additionally, load structures may include not only equipment fasteners, carrier fasteners, and handles, but also may include any suitable structure configured to secure various equipment or other contents together and/or to the carrier, or to function as a loading aid when not in the carrier. For example, load structures may include foam blocks with handles, a soft bag with tie down loops, or injection molded parts. Examples of molded parts that may be suitable as load structures are disclosed in U.S. Pat. No. 4,720,031, the complete disclosure of which is hereby incorporated by reference for all purposes.

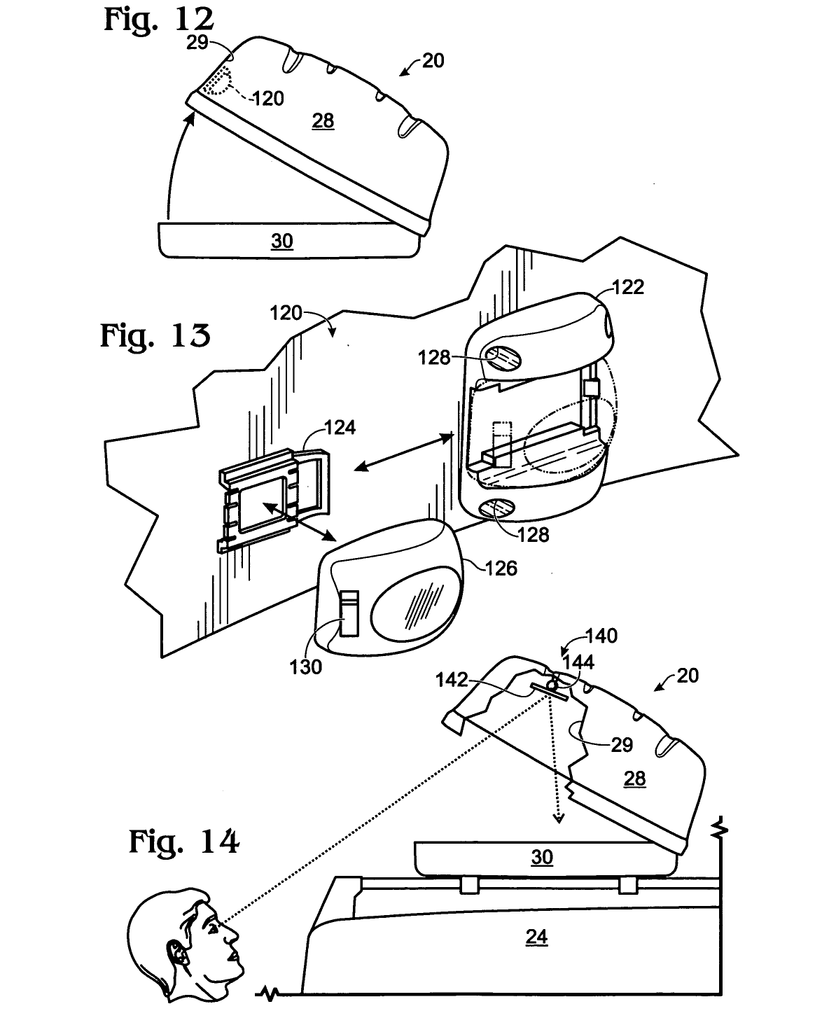

FIG. 12 shows another example of vehicle top carrier 20, equipped with an illumination device 120 attached to the inside of the carrier. Device 120 may be any suitable structure configured to illuminate at least a portion of the inner compartment of the carrier, such as one or more interior lights. The illumination device may include any suitable light emitting structures, such as incandescent bulbs and/or light emitting diodes (LEDs). Additionally, illumination device 120 may be powered via any suitable means, such as one or more batteries and/or one or more solar panels. The illumination device(s) may be located in any suitable location, such as an underside 29 of top 28 of the carrier.

FIG. 13 shows additional details of one embodiment of an illumination device 120 suitable for mounting within carrier 20. Illumination device 120 may include a mounting bracket 122, a slidable mount interface 124, and a mountable light 126. Mounting bracket 122 is configured for attachment to the interior of carrier 20, for example by screwing or bolting through apertures 128 in the bracket, or by adhesion to the carrier using double-sided adhesive tape, blue, or any other suitable adhesive mechanism. Mount interface 124 is configured to slide into bracket 122 and to be securely retained by the bracket, and is shaped to receive and support mountable light 126. Light 126 includes a switch 130, which is any suitable structure configured to switch on and/or off the interior lights. The switches may be operated manually, such as by manual user manipulation, and/or automatically, such as when the top of carrier 20 is raised and/or lowered.

The illumination devices may be configured to be removable from the carrier to allow a user to use those devices for illuminating other areas, or for other suitable purposes. For example, an illumination device may be a snap-in flashlight and/or a stock flashlight held within the internal compartment of the carrier via mount interface 124, such that the flashlight may be conveniently removed from the mount interface and/or mounting bracket and employed for any desired purpose. Furthermore, although only a single illumination device is shown in FIGS. 12-13, any suitable number of illumination devices may be used and located in any suitable location(s) within the carrier. These devices may be equipped with any combination of manual and automatic switches, and may be configured to illuminate any desired portion of the inner compartment of carrier 20, to any desired degree.

FIG. 14 depicts vehicle top carrier 20 equipped with a viewing structure 140, in the form of an adjustable mirror 142 attached to the interior of the carrier. In general, a viewing structure according to the present disclosure may include any suitable structure configured to allow a user to view at least a portion of the inner compartment of the carrier, without requiring the user to climb on the vehicle. This may, for example, allow the user to view at least a portion of the inner compartment from the ground, to determine whether any gear or cargo is disposed in the bottom portion of the carrier without having to achieve a direct line of sight into that portion of the carrier. The carrier may be equipped with multiple viewing structures such as a plurality of mirrors, and the mirrors may be located in any suitable portion of the carrier, such as the underside 29 of carrier top 28.

The mirrors or other provided viewing structures may be separate from or integrated with illumination devices such as those described above, for further convenience in viewing the contents of the carrier. Viewing structures 140 also may include one or more adjustment devices such as a ball joint 144, although in general, an adjustment device according to the present disclosure may include any suitable structure configured to adjust the angle of mirror 142, allowing a user to view at least a portion of the inner compartment of the carrier from any suitable location.

Although vehicle top carriers and features of vehicle top carriers have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

We claim:

1. A carrier configured to be mounted on a roof of a vehicle, comprising:
a box having a top and a bottom including a floor, the box configured for mounting on crossbars of a vehicle roof rack; and
a floor cover sized to fit the floor of the box and configured to create a protective layer on the floor.

2. The carrier of claim 1, wherein the floor cover is constructed from a sound-dampening material.

3. The carrier of claim 1, wherein the floor cover includes at least one floor-conforming structure.

4. The carrier of claim 3, wherein the floor-conforming structure is configured to maintain an at least substantially flat surface on which cargo may rest when the floor cover is installed on the floor of the carrier.

5. The carrier of claim 3, wherein the floor-conforming structure includes at least one rib configured to be at least partially received in a recess of the floor of the carrier.

6. The carrier of claim 5, wherein the at least one rib includes a plurality of ribs configured to be received in a plurality of recesses in the floor of the carrier and to assist in securing the floor cover to the floor of the carrier.

7. The carrier of claim 3, wherein the floor-conforming structure includes at least one aperture configured to accommodate a mounting structure attached to the floor of the carrier.

8. The carrier of claim 7, wherein the aperture is configured to accommodate an internal rail.

9. The carrier of claim 7, wherein the aperture is configured to accommodate an internal tower.

10. The carrier of claim 9, wherein the at least one aperture includes four apertures configured to accommodate four internal towers, and wherein the apertures are sized to allow adjustment of the towers through a series of longitudinal positions within the carrier.

11. The carrier of claim 1, wherein the floor cover includes a fluid containing structure configured to contain liquids and dirt to simplify cleaning of the floor cover.

12. The carrier of claim 11, wherein the fluid containing structure includes a tray formed by an edge lip around a perimeter portion of the floor cover.

13. A carrier configured to be mounted on a roof of a vehicle, comprising:
a box having a top and a bottom including a floor, the box configured for mounting on crossbars of a vehicle roof rack; and
a pair of internal rails attached to the floor and configured to support at least one rack component within the carrier.

14. The carrier of claim 13, further comprising at least two internal towers configured to attach securely to the internal rails and to interface with the at least one rack component.

15. The carrier of claim 14, further comprising an internal ski rack component configured to interface with the internal towers and to support and secure at least two pairs of skis.

16. The carrier of claim 14, further comprising a cargo net configured to interface with the internal towers and to secure cargo disposed within the carrier.

17. The carrier of claim 14, wherein the at least one rack component is configured to be rotatably attached to one of the towers in a manner allowing the rack component may be rotated upward and away from the floor of the carrier.

18. The carrier of claim 14, further comprising at least two rack components spaced apart along the length of the carrier, each rack component extending at least partially across the width of the carrier.

19. The carrier of claim 14, further comprising a floor cover configured to fit within the box and to provide a protective layer above the floor of the box, the cover including at least two apertures sized to accommodate the at least two towers.

20. The carrier of claim 19, wherein the at least two towers include at least four towers, and wherein the at least two apertures include at least four apertures sized to accommodate the towers and to allow longitudinal adjustment of the towers along the rails.
